(19) United States
(12) Patent Application Publication
(10) Pub. No.: US 2013/0011821 A1
(43) Pub. Date: Jan. 10, 2013

(54) COURSE RECOMMENDATION SYSTEM AND METHOD

(76) Inventor: Tristan Denley, Clarksville, TN (US)

(21) Appl. No.: 13/441,063

(22) Filed: Apr. 6, 2012

Related U.S. Application Data
(60) Provisional application No. 61/473,049, filed on Apr. 7, 2011.

(51) Int. Cl. G09B 5/00

(52) U.S. Cl. 434/350

(57) ABSTRACT

A system for assisting a student or other user to identify courses that best fit the student's or user's talents and program of study. Ratings can be shown as a number of stars, a number, a letter, or similar indicator. The system combines three criteria to produce each list of courses that it recommends: courses that apply directly to the student's program of study, courses that are the most central to the university curriculum (centrality ranking), and courses that the model predicts the student will achieve the best grades in (grade prediction). The recommended course list may be displayed in a web-based interface that allows each student to find information on his/her recommended course curricula and requirements, as well as class availability in upcoming semesters. Majors or concentrations can also be evaluated and recommended.

This application claims benefit of and priority to U.S. Provisional Application No. 61/473,049, filed Apr. 7, 2011, by Tristan Denley, and is entitled to that filing date for priority. The specification, figures and complete disclosure of U.S. Provisional Application No. 61/473,049 are incorporated herein by specific reference for all purposes.

### FIELD OF INVENTION

This invention relates to an automated system and method for recommending courses for students.

### SUMMARY OF INVENTION

In various embodiments, the present invention comprises a system for assisting a student or other user to identify courses, whether at an academic institution, corporation, or other training center, that best fit the student's or user's talents and program of study.

In one exemplary embodiment, the system assists a college or university student to identify courses that best fit the student's talents and program of study for upcoming semesters or academic periods. Ratings can be shown as a number of stars, a number, a letter, or similar indicator. While the discussion below is in the context of a college or university environment, it should be noted that the present invention can be used in other contexts where classes or training is provided, such as lower-level educational institution, institutional or corporate training, or the like.

In one embodiment, the system employs a grade or performance prediction model to make these determinations and recommendations. This model may combine a number of past grades (or other measures of performance) by a plurality of students in the class or classes with the student user's transcript in order to make individualized recommendations for that student user.

In another embodiment, the system combines three criteria to produce each list of courses that it recommends. First, it limits the suggestions to courses that apply directly to the student's program of study. It then ranks those courses according to two criteria: those courses that are the most central to the university curriculum (centrality ranking); and those courses that the model predicts the student will achieve the best grades in (grade prediction). The recommendations are ranked according to a combination of all of these three contributions. In this way, the system most strongly recommends a course which is necessary for a student to graduate, core to the university curriculum, and in which the student is expected to succeed academically.

The recommended course list may be displayed in a web-based interface on the secure side of a university campus management system. This interface allows each student to find information on his/her recommended course curricula and requirements, as well as class availability in upcoming semesters. For example, the student or user can click on the “View Sections” button, which displays the various class sections that are being offered for that course, and also indicates their availability (e.g., number of seats left open).

A second report or screen available to faculty on the campus management system, provides the rankings and estimated grades for each student. This second report is a tool for academic advising, meant to supplement the advice faculty members provide to their advisees.

The system also may provide enterprise-level reports that build on the grade prediction and course recommendation information. One report is an “at-risk student” report, which uses the generated grade predictions to produce a list of students whose grades in the upcoming semester or academic period place them at risk of low grades or non-retention. Another report is a course demand profile, showing statistics with regard to seats or spaces in a course (e.g., seats taken or booked through the date of the report, spaces available on the “ground” or on the Internet, spaces potentially available but not yet opened), as well as an estimate of demand. Yet another report shows a group of students created by a series of filters. A pooled list of top-10 recommended courses for the group of students is then collated, thereby allowing the educational institution to identify new courses which are or will be potentially in demand from that group of students.

Another interface or report provides recommendations to a student or user for choice of major or concentration. These recommendations come with a rating, which can be shown as a number of stars, a number, a letter, or similar indicator. The ratings are a combination of a prediction of how well the student would perform academically in that major, together with an evaluation of how well the student's current transcript fits with a change to that major. The major recommendations are displayed in a convenient interface that provides information about requirements for the major, careers that the major leads to, a link to a “what if” analysis degree audit of the student's transcript assuming a selection of that major (i.e., “Degree Audit” button); and a link to an interface to actually change to that major (i.e., “Change Major” button).

### BRIEF DESCRIPTION OF THE DRAWINGS

FIG. 1 shows a view of a system user/student interface in accordance with an exemplary embodiment of the present invention.

FIG. 2 shows another view of a system user/student interface in accordance with an exemplary embodiment of the present invention.

FIG. 3 shows another view of a system user/student interface in accordance with an exemplary embodiment of the present invention.

FIG. 4 shows a view of a system faculty interface in accordance with an exemplary embodiment of the present invention.

FIG. 5 shows an at-risk students interface in accordance with an exemplary embodiment of the present invention.

FIG. 6 shows a course demand chart in accordance with an exemplary embodiment of the present invention.

FIG. 7 shows a view of a majors interface in accordance with an exemplary embodiment of the present invention.

### DETAILED DESCRIPTION OF EXEMPLARY EMBODIMENTS

In various embodiments, the present invention comprises a system for assisting a student or other user to identify courses, whether at an academic institution, corporation, or other training center, that best fit the student's or user's talents and program of study. In one exemplary embodiment, the system assists a college or university student to identify courses that best fit the student's talents and program of study for upcoming semesters or academic periods. Ratings can be shown as a number of stars, a number, a letter, or similar indicator. While the discussion below is in the context of a college or university environment, it should be noted that the present invention can be used in other contexts where classes or training is provided, such as lower-level educational institution, institutional or corporate training, or the like.

In one embodiment, the system employs a grade or performance prediction model to make these determinations and recommendations. This model may combine a number of past grades (or other measures of performance) by a plurality of students in the class or classes with the student user's transcript in order to make individualized recommendations for that student user. The model may base the prediction upon the history of past grades in that specific classes by other students, the history of past grades in some or all classes (which may or may not include that specific class) by other students, the history of past grades in other classes by that particular student, or combination thereof.

In another embodiment, the system combines three criteria to produce each list of courses that it recommends. First, it limits the suggestions to courses that apply directly to the student's program of study. It then ranks those courses according to two criteria: those courses that are the most central to the university curriculum (centrality ranking); and those courses that the model predicts the student will achieve the best grades in (grade prediction). The recommendations are ranked according to a combination of all of these three contributions. In this way, the system most strongly recommends a course which is necessary for a student to graduate, core to the university curriculum, and in which the student is expected to succeed academically.

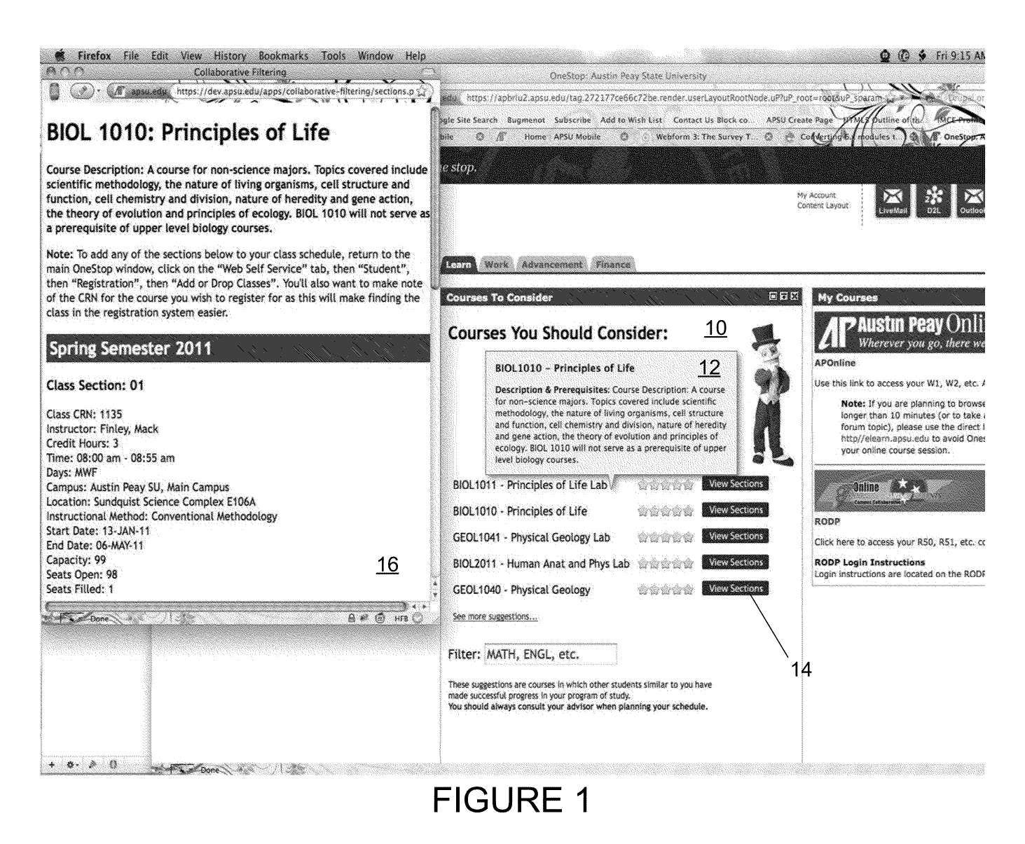

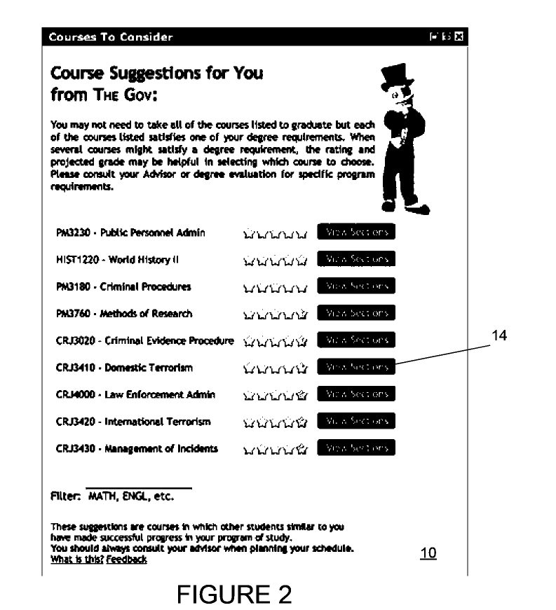

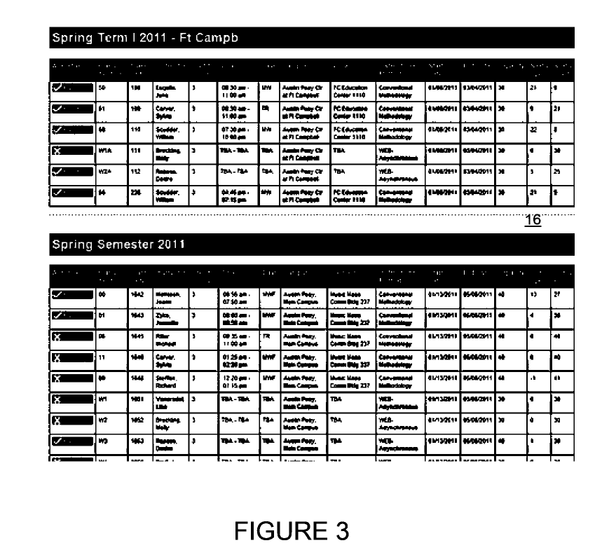

The recommended course list 10 may be displayed in a web-based interface on the secure side of a university campus management system, as seen in FIGS. 1 and 2. This interface allows each student to find information 12 on his/her recommended course curricula and requirements, including specific information about a particular course, which may appear in a separate window, as well as class availability in upcoming semesters. For example, the student or user can click on the “View Sections” button 14, which displays (possibly in a separate window) the various class sections that are being offered for that course, and also indicates their availability (e.g., number of seats left open) 16. An example of a screen showing this information is seen in FIG. 3.

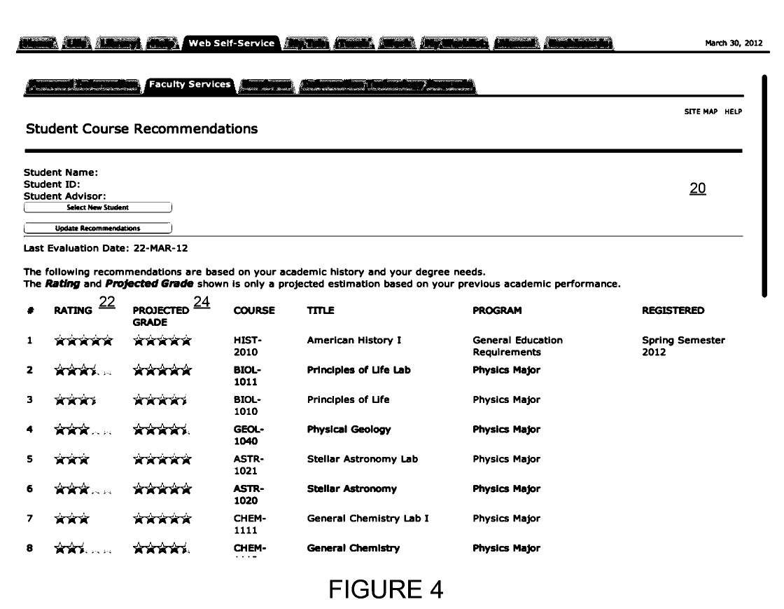

Another report or screen 20, an example of which is seen in FIG. 4, is available to faculty on the campus management system and provides the rankings or ratings 22 and estimated or projected grades 24 for each student. This second report is a tool for academic advising, meant to supplement the advice faculty members provide to their advisees.

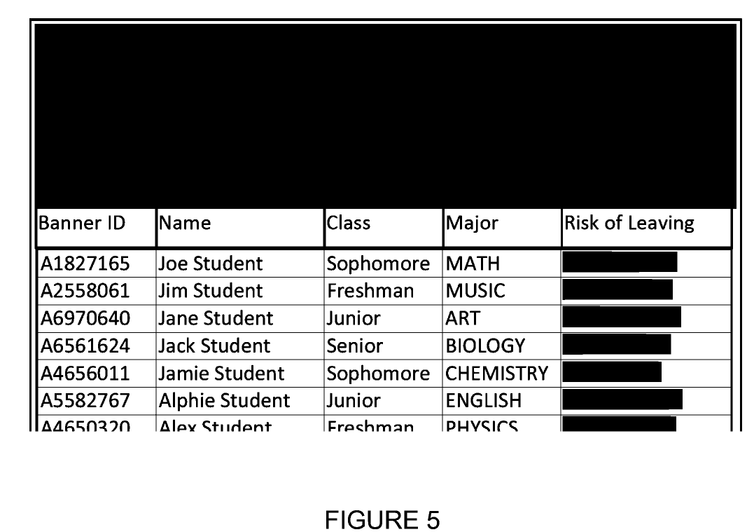

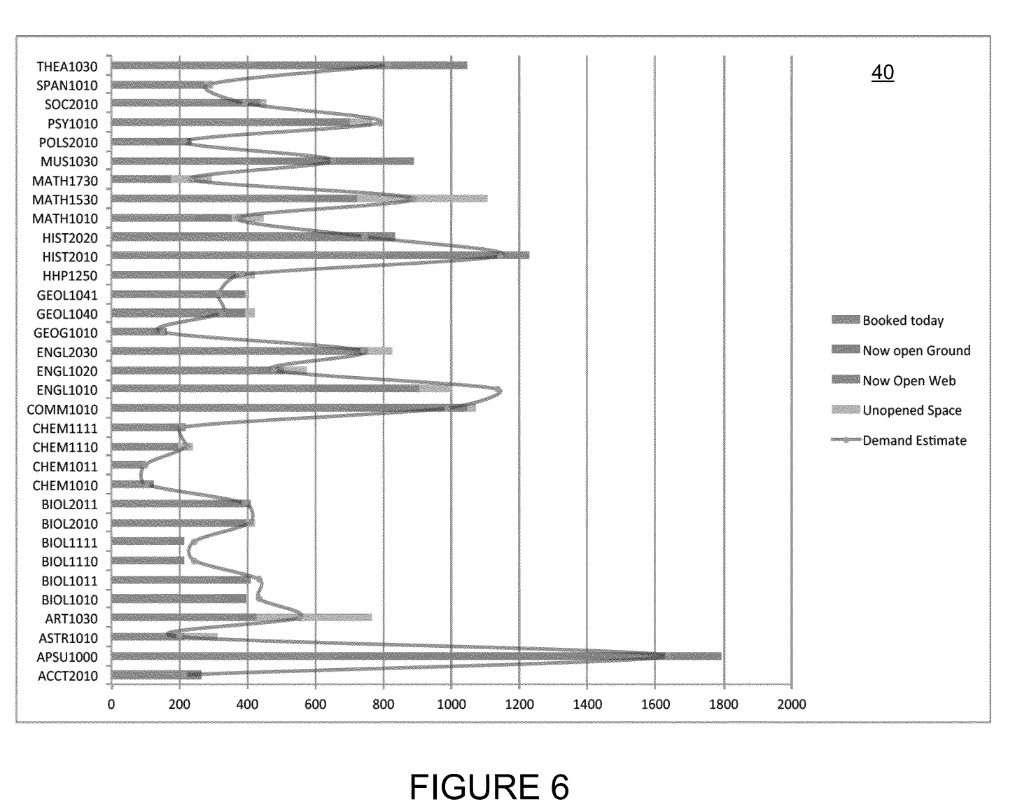

The system also may provide enterprise-level reports that build on the grade prediction and course recommendation information. One report, as shown in FIG. 5, is an “at-risk student” report 30, which uses the generated grade predictions to produce a list of students whose grades in the upcoming semester or academic period place them at risk of low grades or non-retention. The system calculates and displays a “risk of leaving” percentage based upon past history and the grade predictions. Another report, shown in FIG. 6, is a course demand profile 40, showing statistics with regard to seats or spaces in a course (e.g., seats taken or booked through the date of the report, spaces available on the “ground” or on the Internet, spaces potentially available but not yet opened), as well as an estimate of demand. Yet another report shows a group of students created by a series of filters. A pooled list of top-10 recommended courses for the group of students is then collated, thereby allowing the educational institution to identify new courses which are or will be potentially in demand from that group of students.

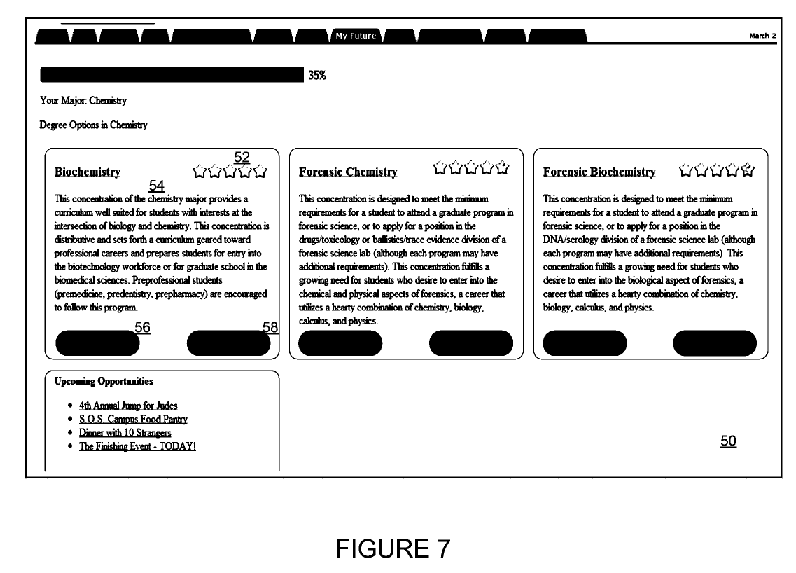

Another interface or report, as shown in FIG. 7, provides recommendations to a student or user for choice of major or concentration 50. These recommendations come with a rating 52, which can be shown as a number of stars, a number, a letter, or similar indicator. The ratings are a combination of a prediction of how well the student would perform academically in that major, together with an evaluation of how well the student's current transcript fits with a change to that major. The major recommendations are displayed in a convenient interface that provides information about requirements for the major, careers that the major leads to, a link to a “what if” analysis degree audit of the student's transcript assuming a selection of that major (e.g., “Degree Audit” button 56); and a link to an interface to actually change to that major (e.g., “Change Major” button 58).

### The Grade Prediction Algorithm

The grade prediction model provides an accurate estimate of the final grade a student will receive in a particular course which they have not yet taken. It employs a grade-based collaborative filter algorithm to create its estimates.

The algorithm begins with the matrix P, comprising a column for every distinct course offered, and a row for each student on record. This matrix with live data may be roughly 3000 columns by 300,000 rows, but varies in size by institution. The entries of P are each an integer 0, 1, 2, 3,4 or 5, representing the grade that the student achieved in that class. In this exemplary embodiment, 0=“Did not take the course”, 1=F, 2=D, 3=C, 4=B, 5=A. Other grading systems may be used. In this way, each row of P contains a student's entire current academic record.

The system then normalizes each column to a unit vector to create the matrix \hat{P}. Now C=\hat{P}^{T}\hat{P} is the matrix of dot products of all pairs of column vectors. This matrix acts a measure of how alike the grade distributions of any two courses are.

Now let \hat{P} be the matrix which is the support of P, and

N=(nᵢⱼ)=^{T}\dot{P}

Then N is the matrix whose entries are the numbers of students who have any two courses together on their transcript. Let

S=(sᵢⱼ)=P^{T}\dot{P}

and A=(aᵢⱼ) where

$${a}_{ij} = \frac{{s}_{ij}}{{n}_{ij}} ,$$

when nᵢⱼ≠0 and 0 otherwise.
Finally, B=(bᵢⱼ)=A−A^{T} is the matrix of the average difference between grades achieved by a student who took courses i and j. The estimate for the grade on course c when it is taken by student s is given by

$$\frac{( {p}_{s *} + {b}_{c *} ) \cdot {c}_{* c}}{{p}_{s *} \cdot {c}_{* c}}$$

where b′ is the row vector of B supported by p_{s*},

The course centrality ranking is decided by using a ranking created from the matrix N. We calculate an eigenvector with all positive entries, of N-diag(N), corresponding to the largest positive eigenvalue, with entries scaled so that the largest entry is 5.

The overall course ranking for a student is determined by ordering his/her courses according to the sum of the course centrality ranking and the predicted grade for that student in each course.

In tests that compared the model's predictions to real student grades, when the model predicted that a student would achieve a C or better it was correct 90% of the time. It was able to successfully predict grades of C or better to within 0.56 of a letter grade on average. What is more, when students' actual grades on courses that the tool would have suggested were compared against grades in courses that would not have been suggested, the grades on the suggested courses were on average 0.46 of a letter grade better.

In one exemplary embodiment, major rankings are generated using transcript information for every student who has graduated from the institution during the last 10 years (or some other substantive period). For a given major M, the fingerprint classes for that particular major are defined as those classes that appear disproportionately often in the transcripts of graduates in those majors. More formally, if a class C appears in a proportion π of the n graduates as a whole, but in a proportion θ of the m graduates in major M, then class Cis a fingerprint class for M if

$$θ - π > X \sqrt{\frac{e ( 1 - θ )}{m} + \frac{π ( 1 - π )}{n}}$$

where X is a suitably chosen parameter which must be calibrated at each institution to ensure that fingerprint classes are particular to each major. Typically, X=9. In this way, the system creates a list of fingerprint classes for every available major and concentration.

Next, the system selects the 10 fingerprint classes that appear most frequently on the transcripts of graduates in major M as the core fingerprint classes for that major. For any given student, the system generates a fingerprint GPA for a given major M by utilizing the course grade prediction model for every core fingerprint course for major M that the student has not yet taken, and combining these with the grades for every fingerprint class the student has already taken. The average of all of these grades gives the fingerprint GPA for that student for major M. The majors can then be ranked for a given student according to the fingerprint GPAs, renormalizing so that the major with the highest fingerprint GPA received the highest ranking (e.g., 5 starts).

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A machine for recommending courses, comprising:
a microprocessor or processor coupled to a memory, wherein the microprocessor or processor is programmed to recommend courses by:
predicting the final grade a student user will receive in one or more courses that the student user has not yet taken; and
determining a list of recommended courses for the student user to take based in part on the final grade predictions.

2. The machine of claim 1, wherein the recommended course list is displayed to the student user through an Internet web browser interface.

3. The machine of claim 1, wherein the list of recommended courses is restricted to courses in the student user's field of study or major.

4. The machine of claim 3, wherein the list of recommended courses is further based in part on the centrality of each course to an educational institution's core curriculum.

5. The machine of claim 1, wherein the final grade prediction for a particular class for the student user is based on the history of prior grades in that class by other students.

6. The machine of claim 1, wherein the final grade prediction for a particular class is based upon the history of prior grades in classes by other students, and the history of prior grades in classes by the student user.

7. The machine of claim 1, wherein the final grade prediction is determined by creating a matrix of grades achieved by students in courses, the matrix comprising a column for every course offered by an educational institution and a row for every student of record.

8. A machine for evaluating a major or concentration at an educational institution, comprising:
a microprocessor or processor coupled to a memory, wherein the microprocessor or processor is programmed to evaluate a major or concentration by:
identifying fingerprint classes for a given major based upon those classes that appear disproportionately often in the transcripts of graduates in that major as compared to graduates as a whole from that educational institution;
determining the grades a student user has received for every fingerprint class the student user has already taken;
predicting the grades a student user will receive for the fingerprint classes the student user has not yet taken; and
averaging the received grades and the predicted grades to determine a predicted grade point average for that student user for that major.

9. The machine of claim 8, further wherein predicted grade point averages for the student user are determined for multiple majors or concentrations.

10. The machine of claim 9, wherein the list of majors and predicted grade point averages are displayed to the student user through an Internet web browser interface.

11. The machine of claim 9, wherein the majors with the highest predicted grade point averages are displayed to the student user as recommended majors.

12. The machine of claim 8, wherein the step of identifying fingerprint classes is based on transcripts of graduates in the last ten years.

13. The machine of claim 8, wherein the step of identifying fingerprint classes comprises selecting the ten classes that appear most frequently.

14. The machine of claim 8, wherein the grade prediction for a particular class the student user has not yet taken is based on the history of past grades in that specific class by other students, the history of past grades in some or all other classes by other students, the history of past grades in other classes by that particular student, or a combination thereof.

15. The machine of claim 14, wherein the final grade prediction is determined by creating a matrix of grades achieved by students in courses, the matrix comprising a column for every course offered by an educational institution and a row for every student of record.

16. A method of recommending courses, comprising the steps of:
predicting, using a microprocessor or processor in a computing device, the final grade a student user will receive in one or more courses that the student user has not yet taken; and
determining a list of recommended courses for the student user to take based in part on the final grade predictions.

17. The method of claim 16, further comprising the step of displaying the list of recommended courses to the student user.

18. The machine of claim 16, wherein the list of recommended courses is restricted to courses in the student user's field of study or major.

19. The machine of claim 16, wherein the list of recommended courses is further based in part on the centrality of each course to an educational institution's core curriculum.

20. The machine of claim 16, wherein the grade prediction for a particular class the student user has not yet taken is based on the history of past grades in that specific class by other students, the history of past grades in some or all other classes by other students, the history of past grades in other classes by that particular student, or a combination thereof.
